(19) United States
(12) Patent Application Publication
(10) Pub. No.: US 2007/0145896 A1
(43) Pub. Date: Jun. 28, 2007

(54) Green sheets, method and apparatus for producing the green sheets, plasma display panels using the green sheets, and methods fabricating the plasma display panels

(76) Inventors: Hong Cheol Lee, Mesan-si (KR); Je Seok Kim, Anyang-si (KR); Byung Gil Ryu, Seoul (KR); Bum Jin Bae, Yongin-si (KR); Nao Seok Kang, Seongnam-si (KR); Dae Hyun Park, Yongin-si (KR); Kyung Ku Kim, Asyong-si (KR); Byung Hwa Seo, Seoul (KR); Min Soo Park, Seoul (KR); Won Seok Jeon, Suwon-si (KR); Dong Oh Shin, Govacheon-si (KR); Deok Hai Park, Jo-ong-gu (KR)

Correspondence Address: KED & ASSOCIATES, LLP, P.O. Box 221200, Chantilly, VA, 20153-1200, US

(21) Appl. No.: 11/602,510

(22) Filed: Nov. 21, 2006

(30) Foreign Application Priority Data
Nov. 22, 2005 (KR) 10-2005-0112014
Jan. 3, 2006 (KR) 10-2006-0000516
Jan. 5, 2006 (KR) 10-2006-0001488

(51) Int. Cl. H01J 17/49; G02F 1/133

(52) U.S. Cl. 313/582

(57) ABSTRACT

Disclosed are green sheets that can be used to shorten the fabrication procedure of plasma display panels and to improve the configuration and crystalline state of electrodes. The green sheets for use in the fabrication of display panels comprise a dielectric layer green sheet to which a plurality of electrode materials are bound at regular intervals, and at least one protective film attached to at least one surface of the dielectric layer green sheet. Further disclosed are a method and an apparatus for producing the green sheets, plasma display panels using the green sheets, and methods fabricating the plasma display panels.

This application claims the benefit of Korean Patent Application No. 10-2005-0112014, filed on Nov. 22, 2005, Korean Patent Application No. 10-2006-0000516, filed on Jan. 3, 2006, and Korean Patent Application No. 10-2006-0001488, filed on January 5, which are hereby incorporated by references as if fully set forth herein.

### BACKGROUND OF THE INVENTION

1. Field of the Invention

The present invention relates to green sheets, a method and an apparatus for producing the green sheets, plasma display panels using the green sheets, and methods for fabricating the plasma display panels. More particularly, the present invention relates to green sheets that can be used to shorten the fabrication procedure of plasma display panels and to improve the configuration and crystalline state of electrodes, a method and an apparatus for producing the green sheets, plasma display panels using the green sheets, and methods fabricating the plasma display panels.

2. Discussion of the Related Art

Plasma display panels (PDPs) are emissive devices that display images using a discharge phenomenon. Since there is no necessity to mount active components on respective cells of PDPs, the fabrication procedure of PDPs is simplified. Other advantages of PDPs are ease of scale-up of screens and high response speed. Based on these advantages, PDPs are currently in the spotlight as display devices of large-screen image displays.

The structure of a general plasma display panel is shown in FIG. 1. As shown in FIG. 1, the plasma display panel comprises an upper panel 10 and a lower panel 20 facing and stacked on the upper panel. The upper panel 10 includes an upper substrate 11 and a plurality of sustain electrode pairs, each of which consists of a transparent electrode 12 and a bus electrode 13.

The sustain electrodes are covered with a dielectric layer 14, and a protective film 15 is formed on the dielectric layer 14.

The lower panel 20 includes a lower substrate 21, a plurality of address electrodes 22 arranged on the lower substrate, a dielectric layer 23 formed on the address electrodes 22, and stripe or well type barrier ribs 24 formed on the dielectric layer 23 to separate respective discharge cells (i.e. discharge spaces) wherein red, blue and green phosphor layers 26 for color display are formed within the cells separated by the barrier ribs 24 to create sub-pixels.

The discharge cells 25 are separated as sub-pixels by the barrier ribs 24. A discharge gas is included in the discharge cells 25. One pixel consists of three sub-pixels.

The bus electrodes 13, particularly those containing silver (Ag), are commonly formed by a process using an electrode paste or a dry film process using a green sheet.

According to the former process, a black matrix (BM) paste is applied over the entire surface of the upper substrate 11, on which the transparent electrode patterns 12 are formed, by printing, and dried.

After the dried structure is exposed to light using a mask for black matrix layers, the exposed portions of the black matrix are etched using a developing solution to form black matrix patterns.

The black matrix patterns are generally formed in non-discharge zones between pairs of transparent electrodes 12. At this time, black layers may also be formed between the pairs of transparent electrodes 12 to increase the contrast of the PDP.

An electrode paste for bus electrodes is printed on the substrate, on which the black matrix patterns are formed, in the same manner as in the formation of the black matrix layers, and dried.

After the dried structure is exposed to light using a mask for electrodes, etching is performed using a developing solution to form patterns. Thereafter, the patterns are calcined to form the bus electrodes 13.

However, the process using a paste and the dry film process for forming electrodes are space and time consuming because they require the use of additional equipment, such as printers and masks for printing, for the printing and drying steps, and involve an additional drying step.

Silver (Ag) present in the paste used to form the electrodes is in the form of particles, and a vehicle (e.g., an organic binder) is used together with the silver particles to form the patterns. The patterns are sintered to have a crystalline state.

That is, when silver (Ag) particles 27 present in a paste or a green sheet are subjected to calcination, they are sintered to form crystalline electrodes 28. The formation of the crystalline electrodes 28 is illustrated in FIGS. 2 and 3.

The characteristics of silver (Ag) contained the crystalline silver (Ag) electrodes 28 are poor as compared to those of the bulky silver (Ag) raw material. That is, the crystalline state of the silver (Ag) electrodes 28 affects the resistance and other electrical properties of the electrodes 28.

As indicated by the dotted lines shown in FIG. 3, many interfaces 29 are present in the silver (Ag) crystals prepared by calcining silver (Ag) particles. The presence of the interfaces 29 causes a deterioration in the characteristics of silver (Ag) contained in the crystalline silver (Ag) electrodes 28, compared to those of the bulky raw material. Particularly, the electrical resistance of the electrodes 28 is greatly increased at the interfaces 29.

Moreover, the conventional processes for forming silver (Ag) electrodes become obstacles in forming electrodes of panels with high definition.

Increases in the size and degree of crystallization of silver (Ag) particles are considered as improvements in the formation of silver (Ag) electrodes.

In addition, bus electrodes and a dielectric layer are formed by different processes, making the overall procedure complicated. Furthermore, since light exposure and development steps are carried out to form bus electrodes, a loss in materials of the photosensitive electrode paste applied to areas other than the bus electrodes may be caused.

On the other hand, the structures of black matrix layers formed in an active area where images are actually displayed are different from those of black matrix layers formed in a pad area other than the active area, resulting in damage to the structure of electrodes formed on the respective black matrix layers.

As apparent from FIG. 4 and FIGS. 5A, 5B and 5C, which are cross-sectional views of the regions ‘a’, ‘b’ and ‘c’ shown in FIG. 4, respectively, a black matrix layer 16 is formed on portions of the surfaces of two transparent electrodes 12 formed on an upper substrate 11 and on a portion of the surface of the upper substrate 11 exposed between the transparent electrodes in an active area (the region ‘a’), whereas black matrix layers 16 are formed only on portions of the surface of an upper substrate 11 where bus electrodes 13 are to be formed in a pad area (the region ‘b’), or a black matrix layer 16 is formed only on a portion of the surface of an upper substrate 11 where a bus electrodes 13 is to be formed in a pad area (the region ‘c’).

As demonstrated from the fabrication procedure of a PDP, since a paste for black matrix layers and a paste for bus electrodes are screen-printed and dried to form the black matrix layers 16 and the bus electrodes 13, the use of equipment for the screen printing is required and the drying step is additionally involved.

When a paste for black matrix layers is exposed to light using a mask for black matrix layers, only the active area (the region ‘a’) is exposed and the pad area (the regions ‘b’ and ‘c’) are not exposed. As a result, since the black matrix layers 16 are not cured before calcining, there is a high probability that the patterns formed in the pad area will collapse upon development and calcination of the patterns. This collapse of the patterns may damage the structure of the electrodes formed on the black matrix layers.

### SUMMARY OF THE INVENTION

Accordingly, the present invention is directed to green sheets, a method and an apparatus for producing the green sheets, plasma display panels using the green sheets and methods fabricating the plasma display panels that substantially obviate one or more problems due to limitations and disadvantages of the related art.

An object of the present invention is to provide plasma display panels and method for fabricating the plasma display panels by which the fabrication procedure is simplified, loss of materials for electrodes can be prevented, and electrode patterns can be formed without involving any drying step.

Another object of the present invention is to provide green sheets that solve problems arising from alignment between black matrix layers and electrodes in a pad area, avoid the collapse of patterns upon development and calcination of the patterns to make the patterns fine, and improve the configuration and crystalline state of the electrodes to lower the electrical resistance of the electrodes, resulting in an improvement in the overall efficiency of panels; a method and an apparatus for producing the green sheets; plasma display panels using the green sheets; and methods fabricating the plasma display panels.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a green sheet for use in the fabrication of a display panel comprises a dielectric layer green sheet to which a plurality of electrode materials are bound at regular intervals; and at least one protective film attached to at least one surface of the dielectric layer green sheet.

In another aspect of the present invention, there is provided a green sheet comprising an electrode green sheet; a photosensitive organic material layer disposed on one surface of the electrode green sheet; and a protective film for protecting the electrode green sheet and/or a protective film for protecting the photosensitive organic material layer.

In another aspect of the present invention, there is provided a method for fabricating a plasma display panel, the method comprising applying a photosensitive black matrix green sheet to an upper substrate and exposing the photosensitive black matrix green sheet to light using a mask for black matrix layers; applying an electrode green sheet to the black matrix green sheet and exposing the electrode green sheet to light using a mask for electrodes; and developing the exposed black matrix green sheet and the exposed electrode green sheet.

In another aspect of the present invention, there is provided a method for producing a green sheet, the method comprising attaching a dielectric layer green sheet to one surface of a first protective film and burying electrode materials at regular intervals in the dielectric layer green sheet to bind the electrode materials to the dielectric layer green sheet.

In another aspect of the present invention, there is provided an apparatus for producing a green sheet, the apparatus comprising a pair of first rollers for attaching a dielectric layer green sheet to one surface of a first protective film, an electrode material feeder for forming electrode materials having predetermined patterns on a second protective film, and a pair of second rollers for binding the electrode materials having predetermined patterns formed by the electrode material feeder to the dielectric layer green sheet.

In another aspect of the present invention, there is provided a plasma display panel comprising electrodes formed by forming a silver (Ag) raw material into a thin film.

In another aspect of the present invention, there is provided a plasma display panel comprising an upper panel and a lower panel, each of which including electrodes, wherein at least one electrode of the electrodes is an electrode having a crystal structure of a silver (Ag) raw material.

In another aspect of the present invention, there is provided a method for fabricating a plasma display panel, the method comprising forming a silver (Ag) raw material into a thin-film silver (Ag) layer and transferring the silver (Ag) layer to the surface of an upper or lower substrate, and patterning the silver (Ag) layer to form electrodes.

In yet another aspect of the present invention, there is provided an upper panel of a plasma display panel, the upper panel comprising a substrate; transparent electrodes formed on one surface of the substrate; bus electrodes formed on the respective transparent electrodes, the bus electrodes being formed using a thin film of a silver (Ag) raw material; a dielectric layer covering the transparent electrodes, the bus electrodes and the substrate; and a protective film disposed on the dielectric layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a general plasma display panel;

FIG. 2 is an enlarged view showing a state wherein electrode materials of a conventional plasma display panel are applied;

FIG. 3 is an enlarged view showing a state wherein the electrode materials shown in FIG. 2 are calcined;

FIG. 4 is a top view of an upper panel of a conventional plasma display panel;

FIGS. 5A, 5B and 5C are cross-sectional views of the regions ‘a’, ‘b’ and ‘c’ shown in FIG. 4, respectively;

FIG. 6 is a top view of an upper panel of a plasma display panel according to one embodiment of the present invention;

FIGS. 7A, 7B and 7C are cross-sectional views of the regions ‘a’, ‘b’ and ‘c’ shown in FIG. 6, respectively;

FIG. 8A is a cross-sectional view of a green sheet according to one embodiment of the present invention, and FIG. 8B is a cross-sectional view of a green sheet according to another embodiment of the present invention;

FIGS. 9A through 9E are cross-sectional views illustrating a method for fabricating a plasma display panel according to one embodiment of the present invention;

FIG. 10 is a schematic view illustrating a method for producing a green sheet according to an embodiment of the present invention;

FIG. 11 is a top view illustrating the formation of patterns of bus electrodes using a green sheet of the present invention;

FIG. 12 is a cross-sectional view illustrating the fabrication of a PDP using a green sheet of the present invention;

FIG. 13 is a schematic view illustrating the production of an electrode material of a plasma display panel according to an embodiment of the present invention;

FIGS. 14 through 16 are cross-sectional views illustrating the steps of a method for fabricating a plasma display panel according to another embodiment of the present invention; and

FIG. 17 is a cross-sectional view of a plasma display panel according to another embodiment of the present invention.

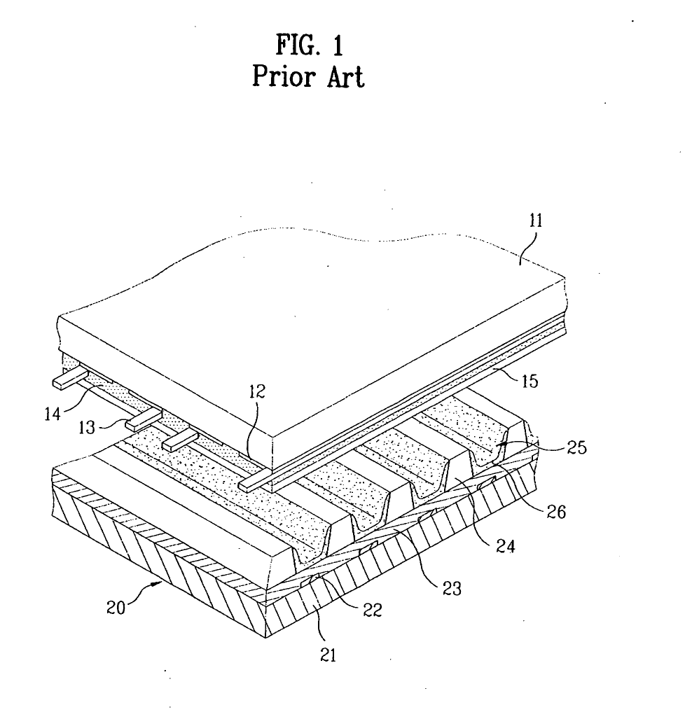

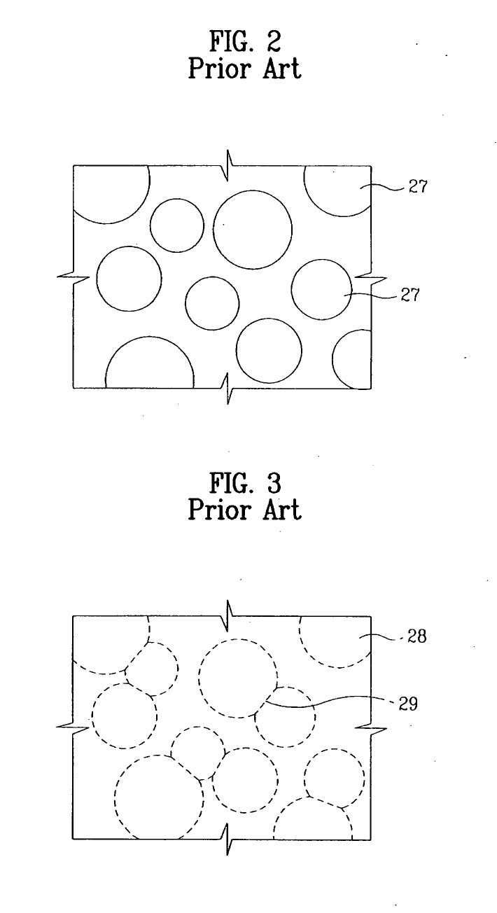

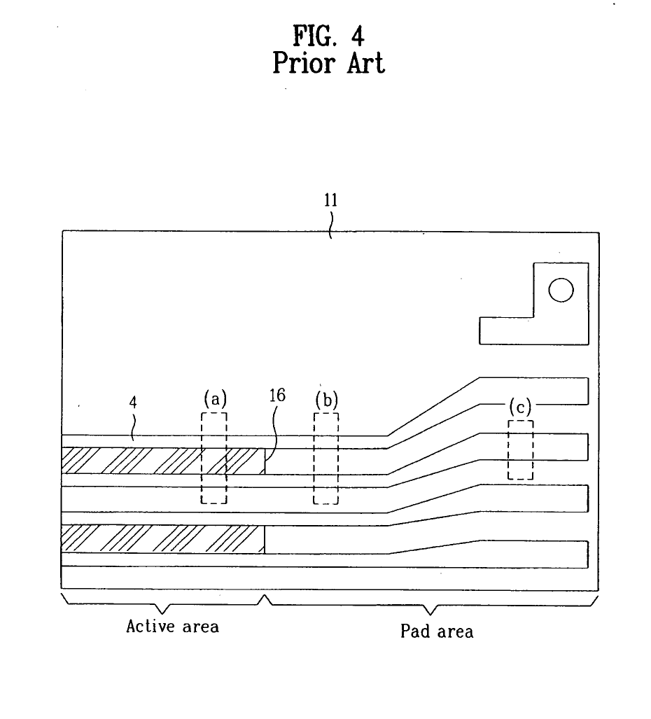

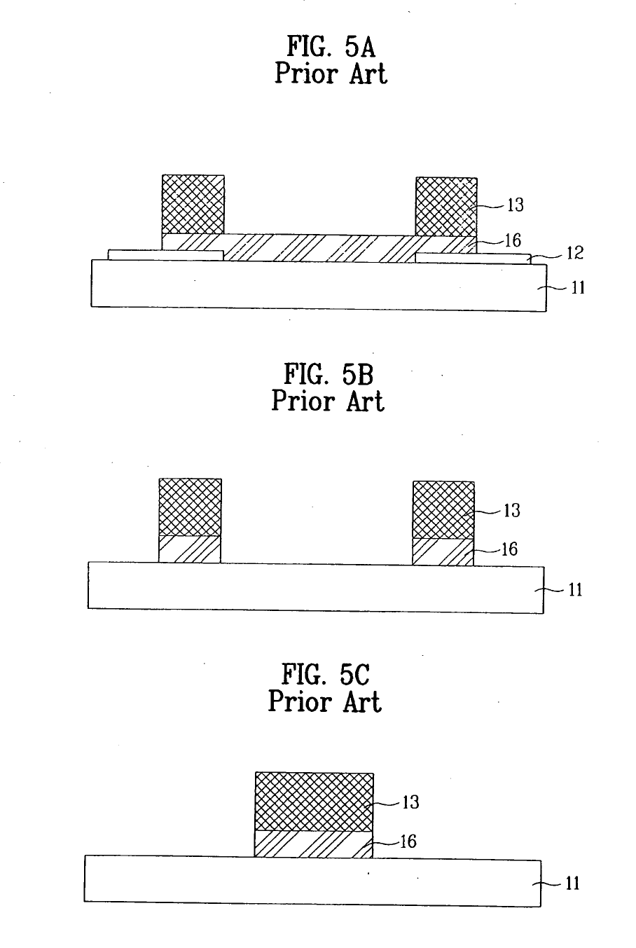

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

### First Embodiment

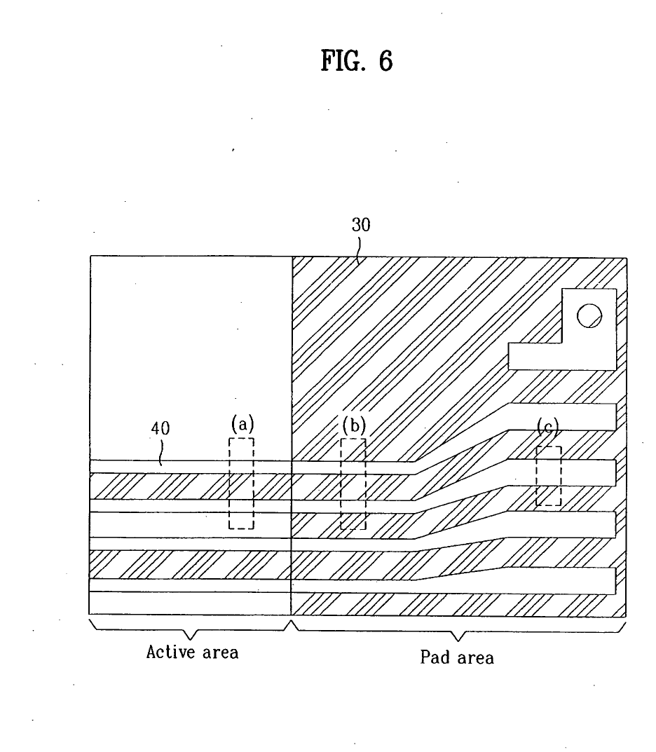

FIG. 6 is a top view of an upper panel of a PDP according to the present invention, and shows that the structures of black matrix layers 30 formed in an active area where images are actually displayed are different from those of black matrix layers 30 formed in a pad area other than the active area.

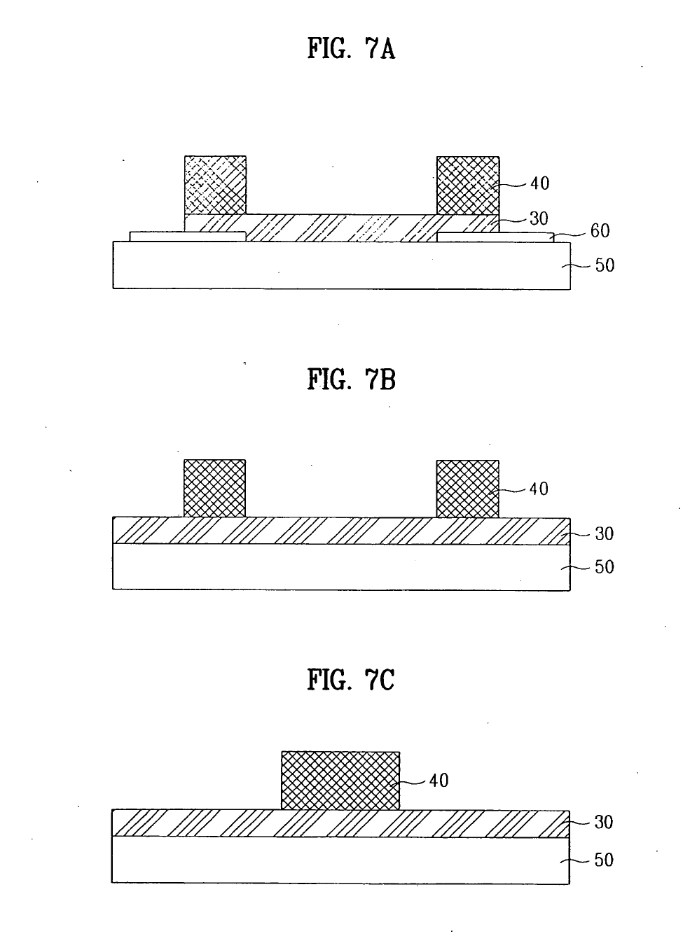

FIGS. 7A, 7B and 7C are cross-sectional views of the regions ‘a’, ‘b’ and ‘c’ shown in FIG. 6, respectively. As is evident from FIGS. 7A, 7B and 7C, a black matrix layer 30 is formed on portions of the surfaces of transparent electrodes 60 formed on an upper substrate 50 and on a portion of the surface of the upper substrate 50 exposed between the transparent electrodes 60 in an active area (the region ‘a’), whereas a black matrix layer 30 is formed on a portion of the surface of an upper substrate 50 where bus electrodes 40 are to be formed as well as on other portions of the surface of the upper substrate 50 in a pad area (the region ‘b’ or ‘c’).

That is, a black matrix layer 30 is formed on portions of the surfaces of two transparent electrodes 60 formed on an upper substrate 50 and on a portion of the surface of the upper substrate 50 exposed between the transparent electrodes 60, as shown in the cross-sectional view of a cell (the region ‘a’) formed in the active area. Meanwhile, a black matrix layer 30 is formed over the entire surface of an upper substrate 50, as shown in the cross-sectional views of the pad area (the region ‘b’ or ‘c’).

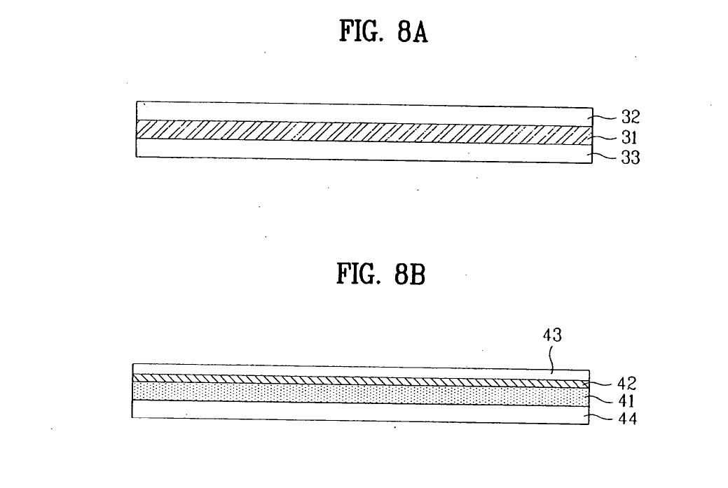

The black matrix layers 30 and the bus electrodes 40 shown in FIG. 6 are formed using respective green sheets. FIGS. 8A and 8B show cross-sectional views of a black matrix green sheet 31 and a bus electrode green sheet 41, respectively.

As shown in FIG. 8A, protective films 32 and 33 are attached to upper and lower surfaces of the black matrix green sheet 31, respectively, to protect the black matrix green sheet 31.

The black matrix green sheet 31 is composed of a negative photosensitive organic material and a powder for black matrix layers having a non-conductive blackness. When the black matrix green sheet 31 is exposed to light, the exposed portions only are cured and remain after development.

As shown in FIG. 8B, a photosensitive organic material layer 42 is formed on the bus electrode green sheet 41, and protective films 43 and 44 are attached to protect the photosensitive organic material layer 42 and the bus electrode green sheet 41, respectively.

The photosensitive organic material layer 42 is formed of a negative photoresist (PR) photosensitive organic material. When the photosensitive organic material layer 42 is exposed to light using a mask for bus electrodes, the exposed portions of the photosensitive organic material layer 21 only remain. The bus electrode green sheet 41 is composed of a silver (Ag) powder and an organic material capable of being dissolved in a developing solution irrespective of light exposure.

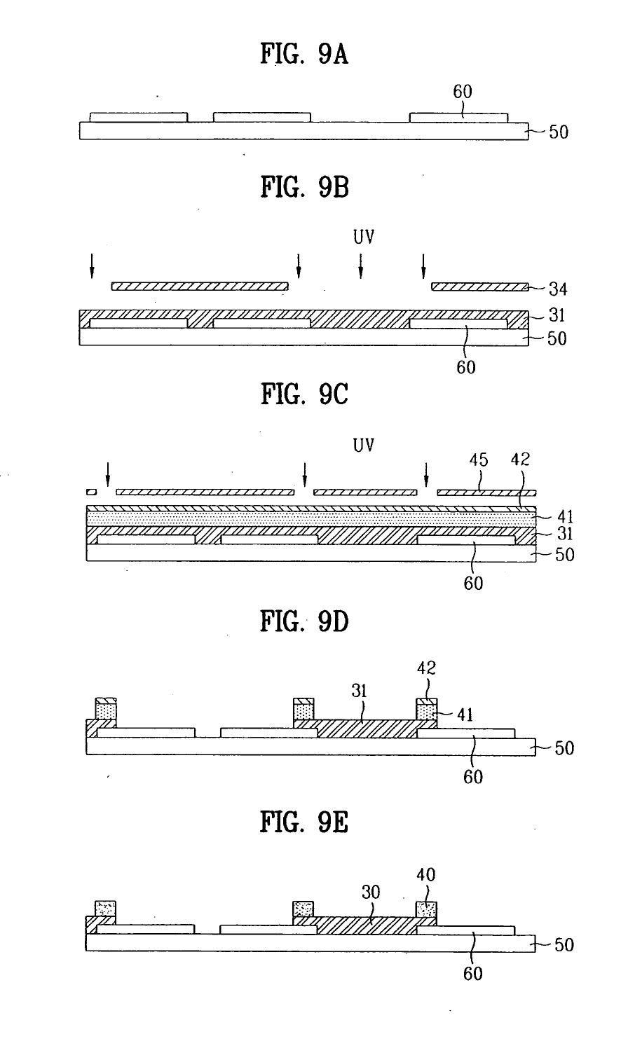

FIGS. 9A through 9E illustrate a method for fabricating a PDP using the black matrix green sheet 31 and the bus electrode green sheet 41 shown in FIGS. 8A and 8B, respectively.

As shown in FIG. 9A, a material (e.g., ITO) is applied to an upper substrate 50a and is then patterned using a patterned mask (not shown) for transparent electrodes to form transparent electrodes 60.

Next, as shown in FIG. 9B, a black matrix green sheet 31 is laminated using a laminator on the upper substrate 50 having the transparent electrodes 60 formed thereon, and then a mask 34 for black matrix layers is disposed over the black matrix green sheet 31. UV irradiation is performed to cure portions of the negative photosensitive organic material contained in the black matrix green sheet 31 where black matrix layers are to be formed.

Then, as shown in FIG. 9C, the bus electrode green sheet 41 and the photosensitive organic material layer 42 are sequentially laminated using a laminator on the exposed black matrix green sheet 31, and a mask 45 for bus electrodes is disposed at a certain distance apart from the photosensitive organic material layer 42. Thereafter, UV irradiation is performed. At this time, only the pattern exposed portions of the photosensitive organic material layer 42, which is formed of a negative PR, formed on the bus electrode green sheet 41 are cured.

Next, as shown in FIG. 9D, the resulting structure is developed with a developing solution, leaving only the cured portions of the photosensitive organic material layer 42 and the black matrix green sheet 31. The uncured portions of the photosensitive organic material layer 42 and the black matrix green sheet 31 are developed by the developing solution. That is, portions of the black matrix green sheet 31 remain on portions of the surfaces of the transparent electrodes 60 and on portions of the surface of the upper substrate 50 exposed between the transparent electrodes 60. The cured portions of the photosensitive organic material layer 42 and the bus electrode green sheet 41 remain only on the portions of the black matrix green sheet 31 formed on the transparent electrodes 60.

The portions of the bus electrode green sheet 41 exposed by patterning the photosensitive organic material layer 42 are dissolved and removed by the developing solution.

Next, as shown in FIG. 9E, the resulting structure is calcined to form black matrix layers 30 and bus electrodes 40. Since the photosensitive organic material layer 42 formed on the bus electrodes 40 is formed of an organic material only, it is completely burned and removed upon calcining.

Following the above procedure, an upper plate structure of the active area where images are actually displayed in a PDP is formed. The formation procedure of black matrix layers in an upper plate structure formed in the pad area is different from that of the black matrix layers in the upper plate structure formed in the active area. It should be noted that transparent electrodes are not formed in the pad area.

That is, when the black matrix green sheet is laminated and irradiated with UV light, the entire portion of the black matrix green sheet laminated in the pad area is exposed and cured without being patterned. As a result, a black matrix layer is formed over the entire surface of the upper substrate 60 in the pad area without being developed.

According to the method of the present invention, since a black matrix layer is formed over the entire surface of an upper substrate in the pad area rather than being formed only in the regions of bus electrodes, the collapse of the patterns, which may occur because the black matrix layer is not exposed, can be prevented. Therefore, the method of the present invention solves problems arising from alignment and enables the formation of fine patterns.

### Second Embodiment

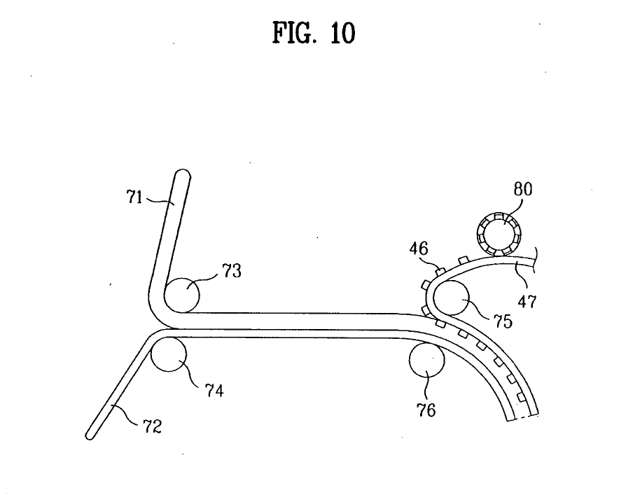

With reference to FIG. 10, an apparatus for producing the green sheets according to the present invention will be explained below.

First, a dielectric layer green sheet 71 is attached to a first protective film 72 by means of a pair of first rollers 73 and 74, and electrode materials 46 are formed on a second protective film 47 by means of an electrode material feeder 80.

The dielectric layer green sheet 71, to which the first protective film 72 is attached, is attached to the second protective film 47, on which the electrode materials 46 are formed, by means of a pair of second rollers 75 and 76.

The apparatus of the present invention serves to apply the dielectric layer green sheet 71 to the first protective film 72 and to bind the electrode materials 46 thereto.

Specifically, the dielectric layer green sheet 71 and the first protective film 72 are passed through the pair of first rollers 73 and 74 to produce a dielectric member, and then the dielectric member and the second protective film 47, on which the electrode materials 46 are formed, are passed through the pair of second rollers 75 and 76 to bind the electrode materials 46 to the dielectric layer green sheet 71.

As shown in FIG. 10, the electrode materials 46 may be arranged at regular intervals on the protective film 47. The electrode materials 46 may be used as bus electrodes of a plasma display panel.

The electrode materials 46 are bound to the dielectric layer green sheet 71 such that they are buried in the dielectric layer green sheet 71. The electrode materials 46 buried in the dielectric layer green sheet 71 can be used to fabricate a plasma display panel.

The electrode materials 46 may be formed on the second protective film 47 by an inkjet printing, dispensing or offset printing technique. Instead of the dielectric layer green sheet 71, a dielectric paste may be used as a dielectric material by screen printing.

The green sheet is produced using the apparatus in accordance with the following procedure. First, a composition for a dielectric layer green sheet is applied to a carrier film and dried to form the dielectric layer green sheet 71 in the form of a film.

Then, the dielectric layer green sheet 71 and the first protective film 72 are passed through a pair of first rollers 73 and 74 such that they are attached to each other.

The first protective film 72 may be formed of polyethylene terephthalate, polyethylene naphthalate or polyethylene. A release agent, such as a silicone resin, may be applied to one surface of the plastic film.

The dielectric layer green sheet 71 is attached to the first protective film 72 to produce a green sheet member, and at the same time, the electrode materials 46 are attached to the second protective film 47.

As mentioned above, the electrode materials 46 may be formed on the second protective film 47 by an inkjet printing, dispensing or offset printing technique.

For example, according to the offset printing technique, a silver (Ag) composition of bus electrodes is injected into a negative plate, adhered to a cylinder of a blanket, and printed between protective films.

The silver (Ag) composition is printed on the protective film 47 to form bus electrodes. Meanwhile, according to the inkjet printing or dispensing technique, an ink containing a silver (Ag) composition for bus electrodes is sprayed on a protective film to form electrode materials.

Then, the dielectric member and the second protective film on which the electrode materials 46 are formed are passed through the pair of second rollers 75 and 76 such that they are attached to each other.

This attachment is performed in such a manner that the electrode materials 46 are buried in the dielectric member. The surface of the electrode materials 46 attached to the second protective film 47 and the surface of the dielectric layer green sheet 71 may be planarized.

That is, in the case where the electrode materials 46 whose one surface is exposed and the dielectric layer green sheet 71 in which the electrode materials are buried are applied to a certain structure in subsequent processing, the electrical connectivity of the electrode materials 46 and the protection effects of the dielectric layer green sheet 71 can be ensured.

An adhesive layer may be further formed to enhance the adhesion of the electrode materials 46 to the dielectric layer green sheet 71. The adhesive layer may be formed by one-time screen printing of a dielectric paste having adhesive properties on the dielectric member.

Since the electrode materials 46 are formed at regular intervals, air bubbles may occur due to the presence of pores when the dielectric layer green sheet 71 is attached to the second protective film 47 on which the electrode materials are formed. The air bubbles may damage electrodes formed from the electrode materials 46. Accordingly, the occurrence of air bubbles must be inhibited as much as possible.

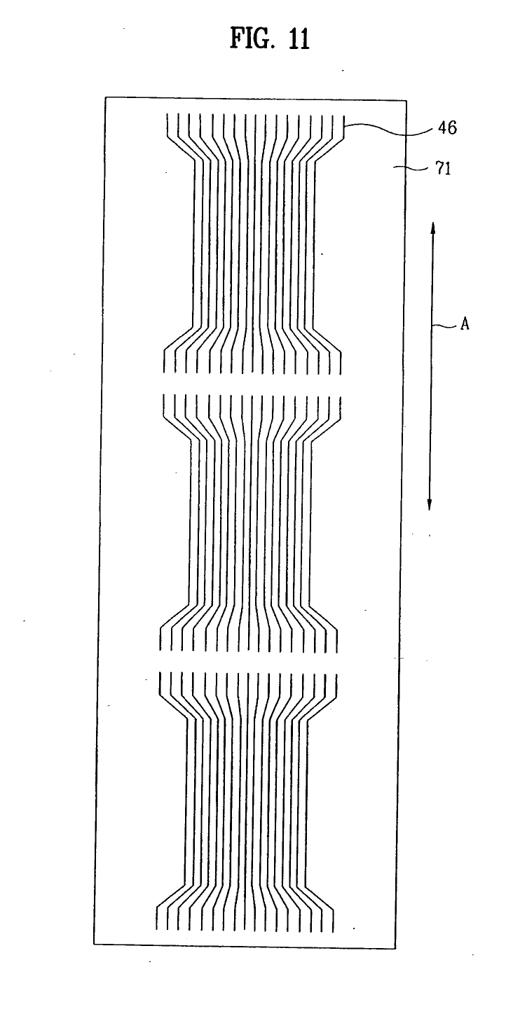

As shown in FIG. 11, patterns of the electrode materials 46 formed along the moving direction (A) of the dielectric layer green sheet 71 are combined with the flowability of the adhesive layer, and the compressive force of the second rollers 75 and 76 is applied thereto to inhibit the occurrence of air bubbles.

As shown again in FIG. 11, the electrode materials 46 formed on the dielectric layer green sheet 71 or the electrode patterns of the electrode materials 46 formed at both ends have a greater width than those formed in the middle portion.

Since the electrodes formed at both ends are connected to respective external connection lines, their width is relatively large. Meanwhile, since the electrodes formed in the middle portion serve to define the columns and rows of pixel cells, they have widths corresponding to the pitch intervals of the pixel cells. At this time, the patterns of the electrode materials 46 are formed along the moving direction (A) of the dielectric layer green sheet 71 to minimize the occurrence of air bubbles due to the presence of pores in the dielectric layer green sheet 71 and the electrode materials 46.

Further, the dielectric paste of the adhesive layer is subjected to embossing by the compressive force of the second rollers 75 and 76 so that it is aligned between the electrode materials 46. At this time, the second rollers 75 and 76 may be heated to enhance the adhesion of the adhesive layer to the electrode materials 46.

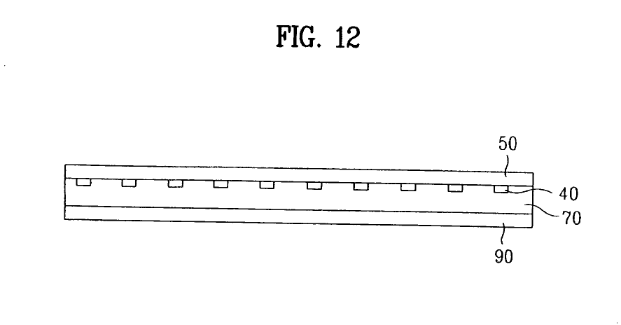

As shown in FIG. 12, the dielectric layer green sheet 71 containing the electrode materials 46 is laminated on the substrate 50 to simultaneously form electrodes 40 and a dielectric layer 70, followed by calcination to produce an upper or lower plate of a PDP.

In conclusion, only two steps, i.e. lamination using the green sheet and calcination, are carried to produce an upper or lower plate of a PDP. Therefore, the overall procedure is simplified and electrodes, e.g., bus electrodes, can be formed without any loss in materials.

### Third Embodiment

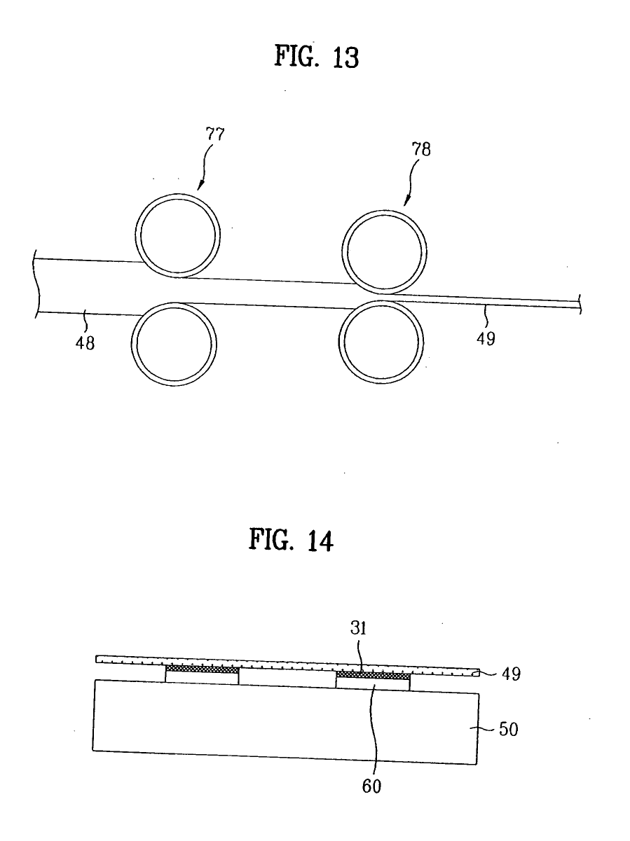

As shown in FIG. 13, a bulky silver (Ag) raw material 48 is used to form an electrode material 49 in the form of a thin film, which may be used to form electrodes of a plasma display panel.

The electrode material 49 may be in the form of a silver (Ag) thin film or foil.

As shown in FIG. 13, the bulky silver (Ag) raw material 48 is formed into a foil by means of a pair of rollers 77, and the foil is further rolled by means of a pair of rollers 78 to produce the final electrode material 49 having a thickness suitable for use in a PDP.

It is to be appreciated that the silver (Ag) raw material 48 may be rolled only one time by means of the pair of rollers 77 to produce the final electrode material 49 having a suitable thickness.

The electrode material 49 having a suitable thickness is softened to control the hardness and ductility of the electrode material.

The electrode material 49 may be laminated on a dry film resist, such as a green sheet, to facilitate the transfer and patterning of electrodes.

Since the electrode material is produced through rolling and softening, the crystal structure of the raw material may remain unchanged.

According to a conventional process using silver (Ag) particles, a silver (Ag) raw material is divided into particles and becomes polycrystals whose crystal structures are isolated. In contrast, according to the present invention, the distance between the crystals of the electrode material 49 can be shortened during rolling and softening, but the structure of the crystals can be maintained despite increased density of the crystals.

Since electrodes of a PDP formed using the thin-film electrode material 49 have a relatively small number of interfaces than conventional electrodes formed using an electrode paste or a green sheet containing silver (Ag) particles, the electrical resistance of the electrodes formed using the thin-film electrode material 49 is not decreased.

Due to excellent electrical properties of the electrode material 49, electrodes can be formed using the electrode material 49 to have a smaller thickness than conventional electrodes.

Conventional electrodes formed using silver (Ag) particles have a thickness of 4 to 5 μm after calcining, whereas electrodes formed using the electrode material 49 preferably have a thickness of 5 to 10 μm.

The electrode material 49 may be used to form bus electrodes in an upper panel or address electrodes in a lower panel of a PDP.

Bus electrodes of a PDP are formed using the electrode material 49 in accordance with the following procedure.

First, transparent electrodes 60 are formed on a substrate 50. Black matrix layers 31 are formed on the respective transparent electrodes 60.

Then, as shown in FIG. 14, the electrode material 49 is transferred to the surfaces of the black matrix layers 31.

On the other hand, the black matrix layers 31 formed on the transparent electrodes 60 may be extended to non-discharge zones between the pair of the transparent electrodes 60 to increase the contrast of a panel. In this case, the black matrix layers (black layers) formed in non-discharge zones have insulating properties.

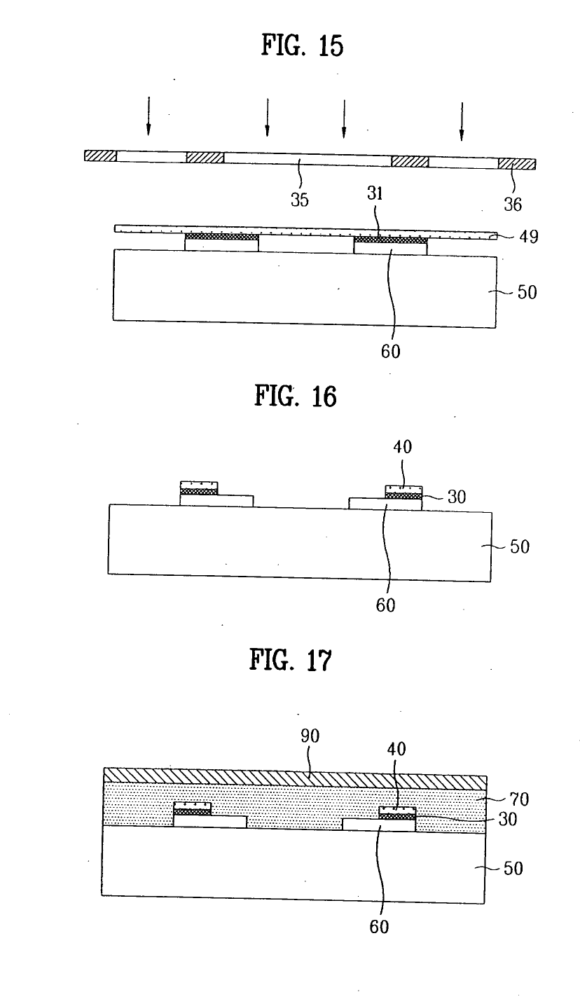

Then, as shown in FIG. 15, etching is performed using a mask 36 having openings 35 to pattern the electrode material 49 into electrode patterns. As a result, electrodes 40 are formed (FIG. 16).

It is desirable that the electrode material 49 be etched using an acid because it is formed of silver (Ag).

The black matrix layers 31 are viscous, causing no difficulty in transferring the electrode material 49 to the surfaces of the black matrix layers 31.

In the case where the electrode material 49 is directly transferred to the surfaces of the transparent electrodes 60 in the absence of the black matrix layers 31, an adhesive may be used.

As shown in FIG. 17, a dielectric layer 70 is formed to cover the electrodes 60 and 40, and a protective film 90 is formed to cover the dielectric layer 70 to complete the production of an upper panel.

On the other hand, the electrode material 49 may be used to form address electrodes on a lower substrate. In this case, the address electrodes are formed by forming an under layer on the lower substrate, transferring the electrode material 49 to the surface of the under layer, and patterning the electrode material.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A green sheet for use in the fabrication of a display panel, the green sheet comprising:
a dielectric layer green sheet to which a plurality of electrode materials are bound at regular intervals; and
at least one protective film attached to at least one surface of the dielectric layer green sheet.

2. The green sheet according to claim 1, wherein the electrode materials are buried at regular intervals in the dielectric layer green sheet to be bound to the dielectric layer green sheet.

3. The green sheet according to claim 1, wherein the electrode materials are used to form bus electrodes of a plasma display panel.

4. A green sheet comprising:
an electrode green sheet;
a photosensitive organic material layer disposed on one surface of the electrode green sheet, and
a protective film for protecting the electrode green sheet and/or a protective film for protecting the photosensitive organic material layer.

5. The green sheet according to claim 4, wherein the photosensitive organic material layer is formed of a photoresist (PR) photosensitive organic material.

6. The green sheet according to claim 4, wherein the electrode green sheet is composed of a mixture of an electrode powder and an organic material capable of being removed by a developing solution.

7. The green sheet according to claim 4, wherein the electrode green sheet is composed of a mixture of electrodes in the form of foils and an organic material capable of being removed by a developing solution.

8. A method for fabricating a plasma display panel, the method comprising:
applying a photosensitive black matrix green sheet to an upper substrate and exposing the photosensitive black matrix green sheet to light using a mask for black matrix layers;
applying an electrode green sheet to the black matrix green sheet and exposing the electrode green sheet to light using a mask for electrodes; and
developing the exposed black matrix green sheet and the exposed electrode green sheet.

9. The method according to claim 8, wherein the black matrix green sheet in a pad area other than an active area where images are actually displayed is entirely exposed.

10. The method according to claim 8, wherein, upon development, the electrode green sheet is patterned by the exposed portions of the photosensitive organic material layer and the portions removed from the photosensitive organic material layer by the patterning are removed by a developing solution.

11. A method for producing a green sheet, the method comprising:
attaching a dielectric layer green sheet to one surface of a first protective film; and
burying electrode materials at regular intervals in the dielectric layer green sheet to bind the electrode materials to the dielectric layer green sheet.

12. The method according to claim 11, wherein the electrode materials are attached to a second protective film and bound to the dielectric layer green sheet.

13. The method according to claim 11, wherein the electrode materials are formed on the second protective film by an inkjet printing, dispensing or offset printing technique.

14. The method according to claim 11, wherein the burial of the electrode materials at regular intervals in the dielectric layer green sheet is performed by means of a pair of rollers.

15. An apparatus for producing a green sheet, the apparatus comprising:
a pair of first rollers for attaching a dielectric layer green sheet to one surface of a first protective film;
an electrode material feeder for forming electrode materials having predetermined patterns on a second protective film; and
a pair of second rollers for binding the electrode materials having predetermined patterns formed by the electrode material feeder to the dielectric layer green sheet.

16. A plasma display panel comprising electrodes formed by forming a silver (Ag) raw material into a thin film.

17. The plasma display panel according to claim 16, wherein the electrodes have a thickness of 5 to 10 μm.

18. The plasma display panel according to claim 16, wherein the crystal structure of the silver (Ag) raw material is maintained.

19. The plasma display panel according to claim 16, wherein the electrodes is produced using a material prepared by rolling the silver (Ag) raw material.

20. The plasma display panel according to claim 16, wherein the electrode material is in the form of a silver (Ag) thin film or foil.

21. The plasma display panel according to claim 16, wherein the electrodes are disposed on black matrix layers.

22. The plasma display panel according to claim 21, wherein the black matrix layers are connected to black layers formed on respective transparent electrodes.

23. The plasma display panel according to claim 16, wherein the electrodes are disposed on black layers formed on respective transparent electrodes.

24. The plasma display panel according to claim 16, wherein the electrodes are bus electrodes or address electrodes.

25. A plasma display panel comprising an upper panel and a lower panel, each of which including electrodes, wherein at least one electrode of the electrodes is an electrode having a crystal structure of a silver (Ag) raw material.

26. A method for fabricating a plasma display panel, the method comprising:
forming a silver (Ag) raw material into a thin-film silver (Ag) layer and transferring the silver (Ag) layer to the surface of an upper or lower substrate; and
patterning the silver (Ag) layer to form electrodes.

27. The method according to claim 26, wherein the silver (Ag) layer is transferred to the surfaces of black matrix patterns formed on the upper substrate.

28. The method according to claim 26, wherein the silver (Ag) layer is in the form of a silver (Ag) foil.

29. The method according to claim 26, wherein the step of forming a silver (Ag) layer includes rolling a silver (Ag) raw material into a thin film and softening the thin-film silver (Ag) material.

30. The method according to claim 29, further including laminating the softened thin-film silver (Ag) material on a dry film resist (DFR).

31. The method according to claim 26, wherein the patterning is performed by etching.

32. The method according to claim 31, wherein the etching is performed using an acid.

33. The method according to claim 26, wherein the transfer is performed by forming an under layer on the lower substrate and transferring the silver (Ag) layer to the surface of the under layer.

34. An upper panel of a plasma display panel, the upper panel comprising:
a substrate;
transparent electrodes formed on one surface of the substrate;
bus electrodes formed on the respective transparent electrodes, the bus electrodes being formed using a thin film of a silver (Ag) raw material;
a dielectric layer covering the transparent electrodes, the bus electrodes and the substrate; and
a protective film disposed on the dielectric layer.

35. The upper panel according to claim 34, further comprising black layers formed between the transparent electrodes and the bus electrodes.

36. The upper panel according to claim 35, wherein the black layers are connected to black matrix layers.
